(19) United States
(12) Patent Application Publication
(10) Pub. No.: US 2018/0029768 A1
(43) Pub. Date: Feb. 1, 2018

(54) CARTON AND CARTON BLANK

(71) Applicant: WestRock Packaging Systems, LLC, Norcross, GA (US)

(72) Inventor: Patrick Blin, Chateauroux (FR)

(21) Appl. No.: 15/551,163

(22) PCT Filed: Feb. 15, 2016
(86) PCT No.: PCT/US16/17927

§ 371 Date: Aug. 15, 2017

(30) Foreign Application Priority Data
Feb. 16, 2015 (GB) 1502582.8

(51) Int. Cl. B65D 71/20; B31B 50/26; B65D 71/32; B65D 5/04; B65D 5/42

(52) U.S. Cl. CPC B65D 71/20; B65D 5/04; B65D 5/4266; B65D 71/32; B31B 50/26; B65D 2571/00277; B65D 2571/00444; B65D 2571/00716; B65D 2571/0066; B31B 2110/40

(57) ABSTRACT

A carton for packaging one or more articles, the carton including a first side panel (22) and a first base panel (24) hingedly connected by a fold line (27). The carton includes at least one article retention structure (L) for engaging a lower portion of an article (A). The at least one article retention structure including at least a first tab (42) struck from, and hingedly connected to, the first side panel and/or the first base panel. The at least a first tab includes an upper portion (42b), a lower portion (42a) and a central portion (42c). The central portion hingedly interconnects the upper and lower portions and is defined by a pair of fold lines (41a, 43a). The fold lines of the pair are divergently arranged with respect to each other.

### FIELD OF THE INVENTION

The present invention relates to a carton and blank for forming the same more specifically, but not exclusively, to a wraparound carton comprising a locking mechanism for locking an article retention structure in a receiving position.

### BACKGROUND OF THE INVENTION

In the field of packaging it is often required to provide consumers with a package comprising multiple primary product containers. Such multi-packs are desirable for shipping and distribution purposes and for the display of promotional information. For cost and environmental considerations, such cartons or carriers need to be formed from as little material as possible and cause as little wastage as possible in the materials from which they are formed. Another consideration is the strength of the packaging and its suitability for holding and transporting large weights of articles.

It is desirable to provide a carton comprising a receiving mechanism for receiving a portion of an article and securely holding said article. It is further desirable to simplify the assembly of a carton comprising such a structure and the loading of the carton with articles.

The present invention seeks to overcome or at least mitigate the problems of the prior art.

### SUMMARY OF INVENTION

According to a first aspect of the present invention there is provided a carton for packaging one or more articles. The carton comprises a first side panel and a first base panel hingedly connected by a fold line. The carton may comprise at least one article retention structure for engaging a lower portion of an article. The at least one article retention structure may comprise at least a first tab struck from, and hingedly connected to, the first side panel and/or the first base panel. At least a portion of the first tab may be folded into overlapping relationship with the first side panel or first base panel. The at least a first tab comprises an upper portion, a lower portion and a central portion. The central portion hingedly interconnects the upper and lower portions and may be defined by a pair of fold lines. The pair of fold lines may be divergently arranged with respect to each other. One of said pair fold lines is arranged such that the at least a first tab is foldable from a first stable position to a second stable position, in the second stable position the at least a first tab is folded internally of the carton for receiving an article.

In some embodiments, said one of said pair fold lines is less foldable than the other of said pair fold lines.

Optionally, the carton comprises a first article retention structure and a second article retention structure each comprising at least a first tab, each of the at least a first tab of each of the first and second article retention structures comprising a cutaway struck at least in part from the upper portion, the cutaways being arranged to prevent the at least a first tab of the first article retention structure overlapping with the at least a first tab of second article retention structure when the at least a first tab of the first article retention structure and the at least a first tab of the second retention structure are disposed in an open condition.

Optionally, the at least one article retention structure comprises a first tab and a second tab each comprising an upper portion, a lower portion and a central portion, the central portion hingedly interconnecting the upper and lower portions and being defined by a pair of fold lines, pair of fold lines being divergently arranged with respect to each other and wherein an aperture is struck at least in part from the upper portion form each of the first and second tabs so as to form a cutaway in each of the first and second tabs.

Optionally, the lower portion of the at least a first tab is foldable into face contacting relationship with the first base panel so as to be disposable between the base panel and an article received in the at least one article retention structure.

In some embodiments, the lower portion of the at least a first tab is struck at least in part from the first base panel.

In some embodiments, the upper portion of the at least a first tab is struck at least in part from the first side panel.

In some embodiments, the central portion of the at least a first tab is struck at least in part from the first side panel.

In some embodiments, the central portion of the at least a first tab is struck at least in part from the first base panel.

Optionally, the pair of fold lines converge at a fold line hinging the first base panel to the first side panel.

According to a second aspect of the present invention there is provided a carton for packaging one or more articles. The carton comprises a first side panel and first base panel hingedly connected by a fold line. The carton may comprise at least one article retention structure for engaging a lower portion of an article. The article retention structure may comprise at least a first tab struck from, and hingedly connected to, the first side panel and/or the first base panel, at least a portion of the first tab being folded into overlapping relationship with the first side panel or first base panel. The at least a first tab may comprise an upper portion, a lower portion and a central portion. The central portion hingedly interconnects the upper and lower portions and may be defined by a pair of fold lines. The pair of fold lines may be divergently arranged with respect to each other and one of said pair fold lines may arranged such that a portion of the at least a first tab is foldable to form an acute angle with respect to a second portion of the at least a first tab when the first side panel is folded to form an acute angle with respect to first base panel.

Optionally, the one of said pair fold lines is less foldable than the other of said pair fold lines.

According to a third aspect of the present invention there is provided a carton for packaging one or more articles, the carton comprising a first side panel and first base panel hingedly connected by a fold line, the carton comprising a first article retention structure and a second article retention structure each for engaging a lower portion of a respective article, each of the first and second article retention structures comprising at least a first tab struck from, and hingedly connected to, the first side panel and/or the first base panel, at least a portion of each of the at least a first tabs being folded into overlapping relationship with the first side panel or first base panel wherein each of the at least a first tab comprise an upper portion, a lower portion and a central portion, the central portion hingedly interconnecting the upper and lower portions and being defined by a pair of fold lines, pair of fold lines being divergently arranged with respect to each other and wherein each of the at least a first tab comprises a cutaway struck at least in part from their respective upper portions, the cutaways being arranged to prevent the at least a first tab of the first article retention structure overlapping with the at least a first tab of the second article retention structure when the at least a first tab of the first and second article retention structures are disposed in an open condition.

Optionally, the one of said pair fold lines is less foldable than the other of said pair fold lines.

According to a fourth aspect of the present invention there is provided a method of constructing a carton from a blank, the blank comprising:
a first side panel and a first base panel hingedly connected by a fold line, the blank comprising at least one article retention structure for engaging a lower portion of an article, the at least one article retention structure comprising at least a first tab struck from, and hingedly connected to, the first side panel and/or the first base panel, at least a portion of the first tab being folded into overlapping relationship with the first side panel or first base panel wherein the at least a first tab comprises an upper portion, a lower portion and a central portion, the central portion hingedly interconnecting the upper and lower portions and being defined by a pair of fold lines, the pair of fold lines being divergently arranged with respect to each other; wherein the method comprises:
folding the at least a first tab out of the plane of the first side panel and a first base panel towards an inner surface thereof such that the at least one article retention structure is in an open condition;
folding the first side panel with respect to the first base panel such that an acute angle is defined therebetween;
transferring the blank to a subsequent processing station in a packaging machine whilst the at least one article retention structure is in the open condition.

Optionally, the method may include:
pre-folding a hinged connection between the first side panel and a first base panel prior to folding the at least one article retention structure into the open condition.

In one optional variation, the blank may include a top panel and the method may include:
transferring the blank with respect at least one article such that the top panel is disposed proximate a top of the at least one article;
folding the first side panel about a first side of the at least one article;
folding the first base panel about a base of the at least one article and in response folding the at least a first tab about a first one of the pair of fold lines;
receiving a portion of each of said at least one articles in a respective one of the at least one article retention structure and in response folding the at least a first tab about a second one of the pair of fold lines.

According to a fifth aspect of the present invention there is provided a blank for forming a carton, the blank comprising a first side panel and a first base panel hingedly connected by a fold line, the blank comprising at least one article retention structure for engaging a lower portion of an article, the at least one article retention structure comprising at least a first tab struck from, and hingedly connected to, the first side panel and/or the first base panel, at least a portion of the first tab being foldable into overlapping relationship with the first side panel or first base panel wherein the at least a first tab comprises an upper portion, a lower portion and a central portion, the central portion hingedly interconnecting the upper and lower portions and being defined by a pair of fold lines, the pair of fold lines being divergently arranged with respect to each other and wherein one of said pair fold lines is arranged such that the at least a first tab is foldable from a first stable position to a second stable position, in the second stable position the at least a first tab is folded internally of the carton for receiving an article.

According to a sixth aspect of the present invention there is provided a blank for forming a carton, the blank comprising a first side panel and first base panel hingedly connected by a fold line, the blank comprising at least one article retention structure for engaging a lower portion of an article, the article retention structure comprising at least a first tab struck from, and hingedly connected to, the first side panel and/or the first base panel, at least a portion of the first tab being folded into overlapping relationship with the first side panel or first base panel wherein the at least a first tab comprises an upper portion, a lower portion and a central portion, the central portion hingedly interconnecting the upper and lower portions and being defined by a pair of fold lines, pair of fold lines being divergently arranged with respect to each other and wherein one of said pair fold lines is arranged such that a portion of the at least a first tab is foldable to form an acute angle with respect to a second portion of the at least a first tab when the first side panel is folded to form an acute angle with respect to first base panel.

According to a seventh aspect of the present invention there is provided a blank for forming a carton, the blank comprising a first side panel and first base panel hingedly connected by a fold line, the blank comprising a first article retention structure and a second article retention structure each for engaging a lower portion of a respective article, each of the first and second article retention structures comprising at least a first tab struck from, and hingedly connected to, the first side panel and/or the first base panel, at least a portion of each of the at least a first tab being folded into overlapping relationship with the first side panel or first base panel wherein each of the at least a first tab comprises an upper portion, a lower portion and a central portion, the central portion hingedly interconnecting the upper and lower portions and being defined by a pair of fold lines, pair of fold lines being divergently arranged with respect to each other and wherein each of the at least a first tab comprises a cutaway struck at least in part from their respective upper portions, the cutaways being arranged to prevent the at least a first tab of the first article retention structure overlapping with the at least a first tab of the second article retention structure when the at least a first tab of the first and second article retention structures are disposed in an open condition.

Within the scope of this application it is envisaged that the various aspects, embodiments, examples, features and alternatives set out in the preceding paragraphs, in the claims and/or in the following description and drawings may be taken independently or in any combination thereof. For example, features described in connection with one embodiment are applicable to all embodiments unless there is incompatibility of features.

### BRIEF DESCRIPTION OF THE DRAWINGS

Exemplary embodiments of the invention will now be described with reference to the accompanying drawings, in which:

FIG. 1 is a plan view from above of a blank for forming a carton according to a first embodiment of the invention;

FIG. 1a is an enlarged view of a portion of the blank of FIG. 1;

FIG. 2 is a perspective view from above of a carton formed from the blank of FIG. 1;

FIG. 3 is an end view of the carton of FIG. 2;

FIGS. 4A and 4B are enlarged perspective views from above of a portion of the carton of FIG. 2;

FIG. 5A is a perspective view from above of an internal portion of the carton of FIG. 2 in which the articles have been removed to illustrate the internal structure;

FIG. 5B is an enlarged perspective view of a portion of the carton shown in FIG. 5A; and

FIGS. 6A to 6E are perspective views of a portion of the blank of FIG. 1 during stages of assembly of the carton.

### DETAILED DESCRIPTION OF EXEMPLARY EMBODIMENTS OF THE PRESENT INVENTION

Detailed descriptions of specific embodiments of the package, blanks and cartons are disclosed herein. It will be understood that the disclosed embodiments are merely examples of the way in which certain aspects of the invention can be implemented and do not represent an exhaustive list of all of the ways the invention may be embodied. Indeed, it will be understood that the packages, blanks and cartons described herein may be embodied in various and alternative forms. The Figures are not necessarily to scale and some features may be exaggerated or minimised to show details of particular components. Well-known components, materials or methods are not necessarily described in great detail in order to avoid obscuring the present disclosure. Any specific structural and functional details disclosed herein are not to be interpreted as limiting, but merely as a basis for the claims and as a representative basis for teaching one skilled in the art to variously employ the invention.

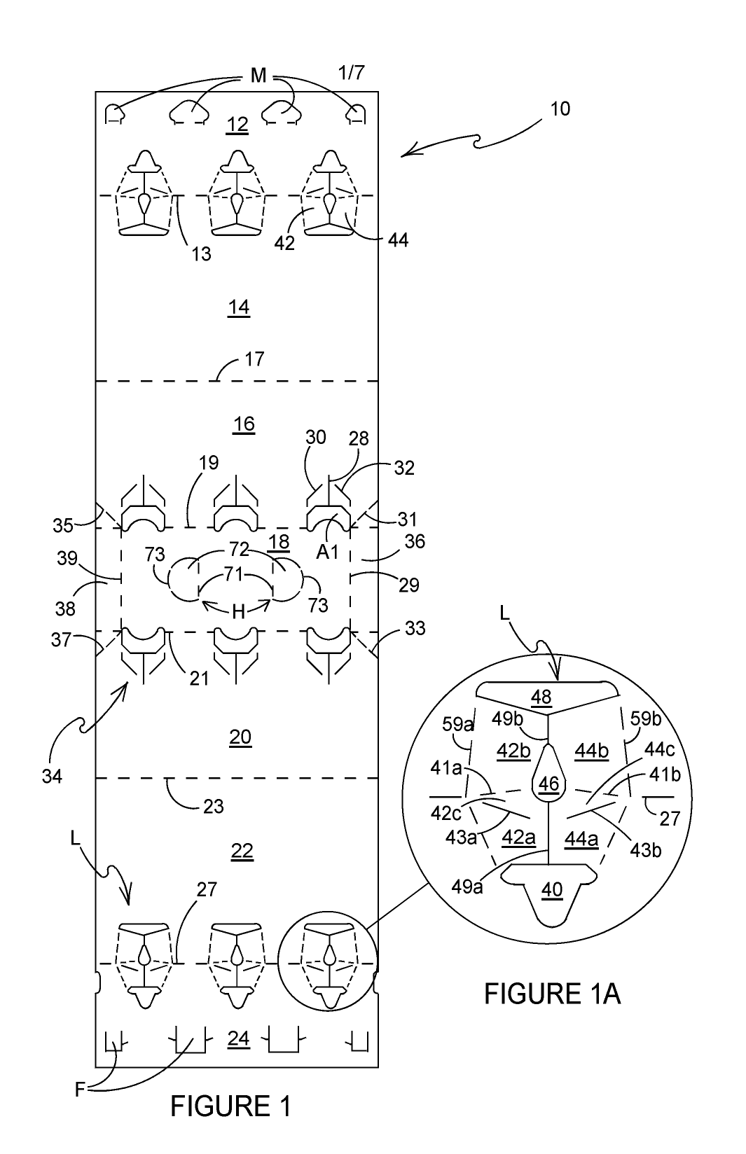

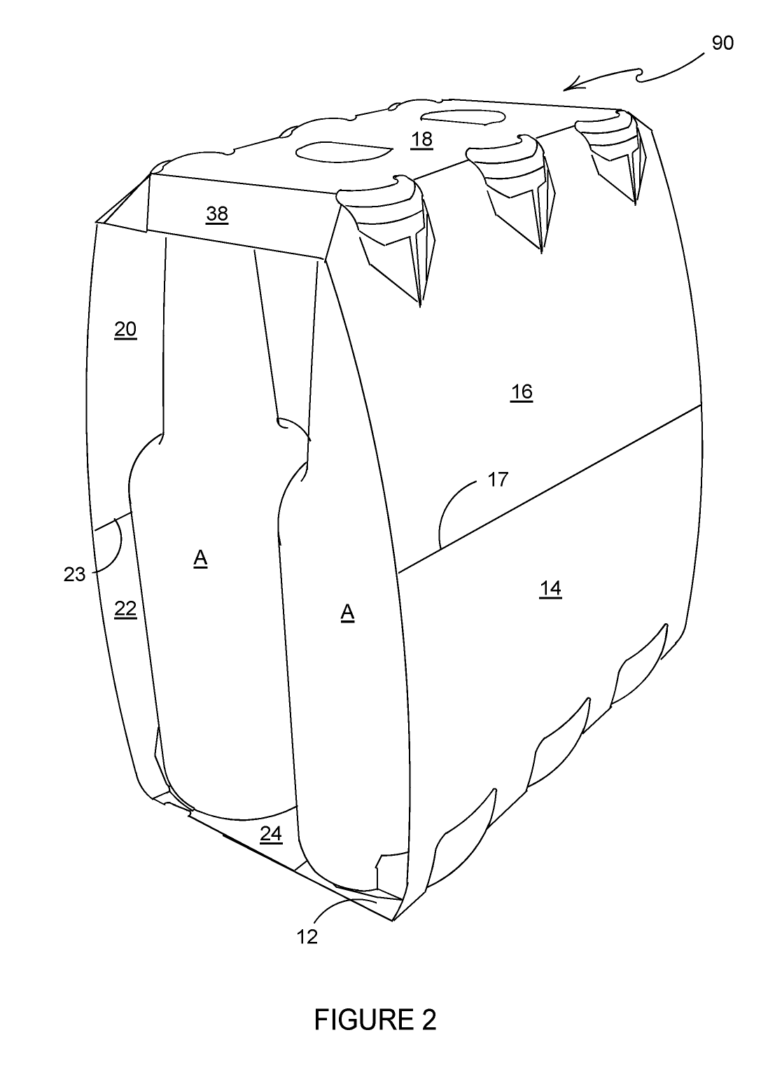

Referring to FIGS. 1 and 2 there is shown a blank 10 for forming a carton 90 capable of accepting an input of primary products such as, but not limited to, bottles or cans, hereinafter referred to as articles A.

The blank 10 comprises a series of main panels 12, 14, 16, 18, 20, 22, 24 hinged one to the next in a linear series. A first base panel 12, which forms part of a composite base panel 12/24 of the carton 90, is hinged to a first lower side wall panel 14 by a hinged connection such as a fold line 13. First lower side wall panel 14 is hinged to a first upper side wall panel 16 by a hinged connection such as a fold line 17. First upper side wall panel 16 is hinged to top panel 18 along a hinged connection such as a fold line 19. Top panel 18 is hinged to second upper side wall panel 20 along a hinged connection such as a fold line 21. Second upper side wall panel 20 is hinged to second lower side wall panel 22 along a hinged connection such as a fold line 23. Second lower side wall panel 22 is hinged to second base panel 24 by a hinged connection such as a fold line 27. Second lower side wall panel 22, together with first base panel 12, forms the composite base panel 12/24 of a carton 90.

First base panel 12 comprises male tabs M; second base panel 24 comprises female tabs F Together, the male and female tabs M, F form a complementary locking mechanism for securing the first and second base panels 12, 24 together.

Top panel 18 comprises a carrying handle H, formed from a pair of finger tabs 72. Each of the finger tabs 72 is defined by an outline or severance line 73 and by a hinged connection such as a fold line 71. In alternative embodiments alternative handle structures may be employed.

Top panel 18 also comprises a pair of transverse hinged connections such as fold lines 29, 39 which extend between fold line 19 and fold line 21; in other words, between the first and second upper side wall panels 16, 20. Transverse fold lines 29, 39 each define in part a respective top end flap 36, 38 for at least partially closing an end of the carton 90.

First and second upper side wall panels 16, 20 comprise one or more upper article retention structures 34. Each upper article retention structure 34 comprises a substantially U-shaped aperture Al. Optionally, each U-shaped aperture Al is disposed adjacent to a respective one of fold lines 19, 21; optionally, each U-shaped aperture Al interrupts the respective fold line 19, 21. The upper article retention structures 34 also comprise first, second and third severance line or cut lines 28, 30, 32.

First cut line 28 extends from a lowermost portion of the U-shaped aperture A1; optionally, the first cut line 28 is substantially perpendicular to a respective one of fold lines 19, 21.

Second and third cut lines 30, 32 each comprise first portions which are convergently orientated with respect to one another, and optionally are additionally convergently orientated with respect to first cut line 28. Second and third cut lines 30, 32 may optionally comprise second portions which are orientated substantially parallel with respect to one another and optionally are substantially parallel with respect to first cut line 28.

First cut line 28 and second cut line 30 define in part a first flap. First cut line 28 and third cut line 32 define in part a second flap.

Each of the upper article retention structures 34 is arranged to accommodate a respective article A of a group of articles A which form a package with the carton 90. In the illustrated embodiment the carton 90 is arranged to accommodate six articles arranged in two rows of three articles. The blank 10 comprises six article retention structures arranged in a 2×3 array for receiving an outermost region of upper portions of each article. In embodiments with more than two rows of articles, it is envisaged that only those articles in the outermost rows will be received in a respective upper article retention structure 34. In yet further alternative embodiments it is envisaged that only those articles disposed adjacent the ends of the carton 90 may be retained in a respective upper article retention structure 34.

Optionally, the first upper side wall panel 16 comprises a hinged connection such as a first fold line 31. First fold line 31 extends from fold line 19 to an adjacent free end edge of first upper side wall panel 16. First fold line 31 defines in part a gusset panel struck from first upper side wall panel 16, which gusset panel is hinged to first top end flap 36. A hinged connection such as a second fold line 35 disposed adjacent a second free end edge, opposing the first free end edge, is provided in the first upper side wall panel 16 and defines a second gusset panel hinged to the second top end flap 38. Likewise second upper side wall panel 20 comprises hinged connections such as a third and a fourth fold line 33, 37 respectively. Each of third and fourth fold lines 33, 37 defines in part a third and fourth gusset panel hinged to a respective one of the first or second top end flaps 36, 38.

The blank 10 comprises a plurality of lower retention structures L. In the illustrated embodiment the blank 10 comprises six lower article retention structures L. Each of the lower retention structures L are substantially similar in construction and will described by reference to the lower retention structures L shown in FIG. 1A.

Each lower retention structure L comprises two tabs 42, 44. First tab 42 comprises three components: upper portion 42b, lower portion 42a and central portion 42c. Upper portion 42b is hinged to central portion 42c by a hinged connection such as a fold line 41a. Central portion 42c is hinged to lower portion 42a by a hinged connection such as a fold line 43a.

Second tab 44 comprises three components: upper portion 44b, lower portion 44a and central portion 44c. Upper portion 44b is hinged to central portion 44c by a hinged connection such as a fold line 41b. Central portion 44c is hinged to lower portion 44b by a hinged connection such as a fold line 43b.

First and second tabs 42, 44 are hinged to the blank 10 along hinged connections such as fold lines 59a, 59b. Optionally, each fold line 59a, 59b is non-linear, or arcuate.

Optionally, the fold lines 59a, 59b comprise two or more linear sections defining an angle therebetween as shown in FIG. 1A.

Fold lines 41a and 43a are arranged to be convergent with respect to one another. Fold lines 41b and 43b are arranged to be convergent with respect to one another. Fold line 41a comprises a first end disposed substantially on fold line 27 and extends therefrom. Fold line 43a comprises a first end disposed substantially on fold line 27 and extends therefrom. Fold line 41b comprises a first end disposed substantially on fold line 27 and extends therefrom. Fold line 43b comprises a first end disposed substantially upon fold line 27 and extends therefrom. Optionally, fold lines 41a, 41b, 43a, 43b are defined by cut lines in the blank 10. In alternative embodiments the fold lines 41a, 41b, 43a, 43b may be defined by score lines, partial cuts, embossed or debossed lines formed in the blank 10. In the illustrated embodiments the fold lines 41a, 41b, 43a, 43b are defined in part by cut lines extending partially across the first tab 42 or the second tab 44 respectively. The cut lines are optionally arranged to be convergently orientated with respect to one another such that they converge towards a hinged connection of the first tab 42 to the blank 10.

First upper portion 42b and second upper portion 44b are struck at least in part from material forming the second lower side wall panel 22. First lower portion 42a and second lower portion 44a are struck from material forming the second base panel 24. First central portion 42c and second central portion 44c are struck in part from material forming the second lower side wall panel 22 and in part from material forming the second base panel 24.

First tab 42 is separated from second tab 44 by a cut line or severance line 49a, 49b and by an aperture 46. Aperture 46 is disposed substantially between the first upper portion 42b and the second upper portion 44b. Optionally, aperture 46 is tear drop shaped.

In the illustrated embodiment the first central portion 42c and second central portion 44c are each substantially triangular in shape.

The lower article retention structures L may also comprise a first, upper, aperture 48 disposed adjacent to and defining an upper edge of each of the first and second upper portions 42b, 44b.

The lower article retention structures L may further comprise a second, lower aperture 40 disposed adjacent to and defining a lower edge of each of the first and second lower portions 42a, 44a.

Second lower aperture 40 may comprise a substantially V-shaped portion wherein the vertex of the aperture 40 is disposed closest to a free edge of base panel 24 opposing an edge comprising the hinged connection to the second lower side wall panel 22. These lower apertures 40 may be engaged by machine tools for facilitating assembly and/or alignment of the carton 90.

Turning to the construction of the carton 90 as illustrated in FIGS. 2 to 6E, it is envisaged that the carton 90 can be formed by a series of sequential folding operations in a straight line machine so that the carton 90 is not required to be rotated or inverted to complete its construction. The folding process is not limited to that described below and may be altered according to particular manufacturing requirements.

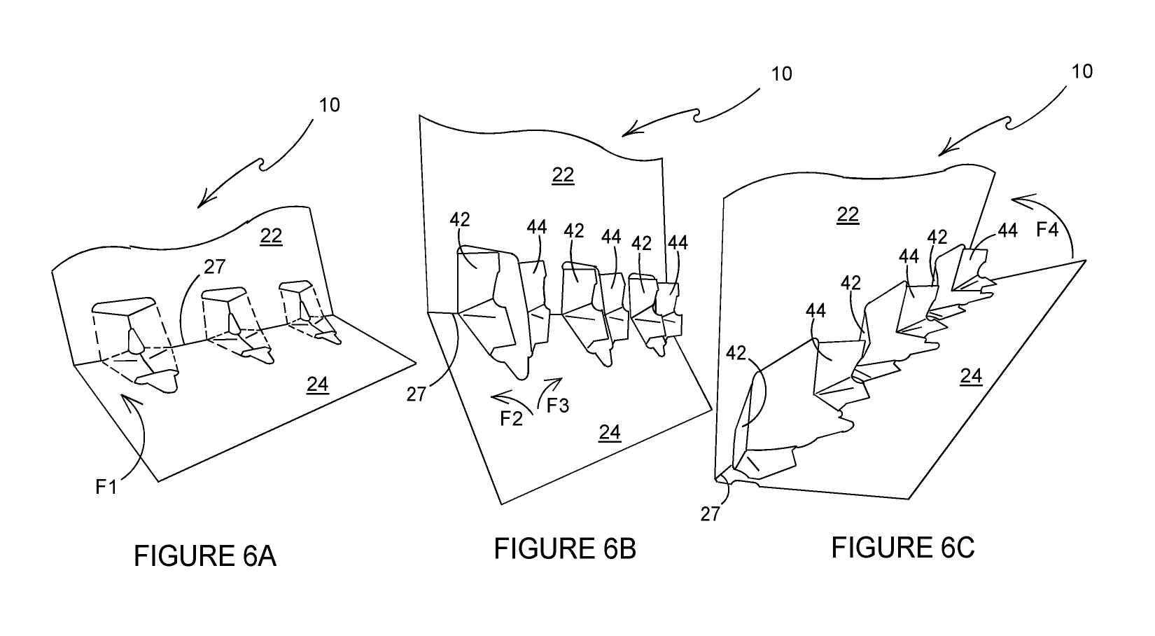

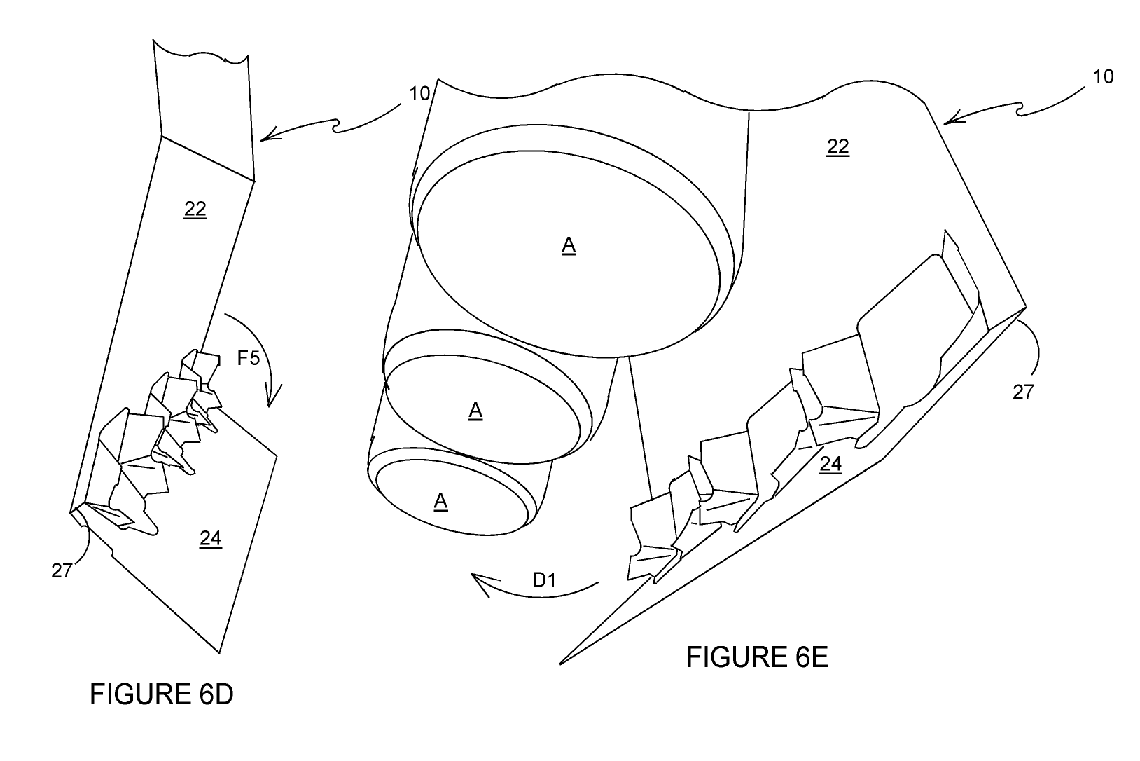

FIG. 6A illustrates base panel 24 of the blank 10 being pre-folded (as indicated by direction arrow F1) with respect to lower side panel 22 along fold line 27, prior to opening of the lower article retention structures L. In FIG. 6A, the article retention structures are in a first stable position or in a closed condition. Similarly, the blank 10 may be folded along fold line 13, prior to opening of the lower article retention structures at the other end of the blank 10.

In FIG. 6B there is shown the second lower side panel 22 and the second base panel 24 of the blank 10. The lower article retention structures L have been opened, the first tabs 42 have been folded internally of the carton 90 about fold lines 59a as indicated by the direction arrow F2, and the second tabs 44 have been folded internally of the carton 90 about fold lines 59b as indicated by the direction arrow F3. Similarly (not shown), the lower article retention structures L formed in the first lower side panel 14 and first base panel 12 of the blank 10 may be opened.

FIG. 6C illustrates the second lower side panel 22 and the second base panel 24 of the blank 10 being further folded toward each other about fold line 27 as indicated by direction arrow F4 such that the lower side panel 22 and the base panel 24 define an acute angle therebetween. In FIG. 6C, the lower article retention structures L are in an open condition wherein the first and second lower portions 42a, 44a and the first and second central portions 42c, 44c may be brought into a face-contacting arrangement with the second base panel 24. The first and second tabs 42, 44 are folded about the fold lines 41a, 41b respectively such that the lower portion 42a defines an acute angle with respect to the upper portion 42b while the lower portion 44a defines an acute angle with respect to the upper portion 44b.

The blank 10 is then released from the folding force which brought the base and side panels 24, 22 into the acute angle condition of FIG. 6C and conveyed to a group of articles. Being released from the folding force, the base panel 24 is allowed to be unfolded to some extent, or otherwise to be folded in a reverse direction (as indicated by the arrow F5 in FIG. 6D) such that an angle greater than aforementioned acute angle is defined between the base panel 24 and the side panel 22. Even after released from the folding force, however, the lower article retention structures L remain in an open condition, as shown in FIG. 6D. This is because arrangement of the fold lines 41a, 41b allows the second base panel 24 to be folded at an acute angle with respect to the second lower side wall panel 22. Such an arrangement allows the lower article retention structures L to remain in an open condition (or in a second stable position) whilst being transferred by a packaging machine to the next processing station. There is no requirement for a machine element or tool to hold the lower article retention structures L in the open condition to retain the lower article retention structures L in the open condition. In other words, the first and second tabs 42, 44 comprise an over-centre or bi-stable spring mechanism by which the first and second tabs 42, 44 are stable in both a closed condition (the first stable position of FIG. 6A) and an open condition (the second stable position of FIG. 6D). In some embodiments, when the blank is formed form a paperboard or cardboard material, the fibres of the material may be broken along the fold lines 41a, 41b during the acute angle folding step of FIG. 6C, such that the inherent resilience of the material is reduced. In this way, the likelihood to the lower article retention structures L returning to the closed condition, or otherwise to an unfolded condition, is reduced. It will be appreciated that in other embodiments when the carton 90 is formed from alternative materials such as, but not limited to, plastics materials the inherent resilience of the material can be reduced by folding the material through a greater angle, for example but not limited to greater than 90°, 120°, 135°.

The fold lines 41a, 41b are arranged, positioned and orientated, such that the first and second upper portions 42b, 44b can be folded about fold lines 41a, 41b with respect to the first and second central portions 42c, 44c and/or to the first and second lower portions 42a, 44a through an angle greater than 90° when the first or second base panel 12, 24 is folded, about respective fold lines 13, 27, with respect to the first or second lower side wall panels 14, 22 through an angle greater than 90° (FIG. 6C). An inside surface of the first and second base panels 12, 24 is folded towards an inside surface of the respective adjacent first or second lower side wall panel 14, 22.

Optionally, fold line 43a is arranged to be structurally weaker or less resistant to external folding force than the fold line 41a. Optionally, fold line 43b is arranged to be structurally weaker or less resistant to external folding force than the fold line 41b.

For example, but not limited to, the fold lines 41a, 41b may be formed of a series of aligned short slits while the fold lines 43a, 43b may be formed of one or more short slits each having a greater length than each of those slits forming the fold lines 41a, 41b.

The number of the short slits provided in the fold line 43a may be greater than the number of the short slits in the fold line 41a and wherein the length of the fold line 43a may be substantially equal to the length of the fold line 41a. Similarly, the number of the short slits provided in the fold line 43b may be greater than the number of the short slits in the fold line 41b and wherein the length of the fold line 43b may be substantially equal to the length of the fold line 41b.

In this way, the fold line 43a is more readily foldable than the fold line 41a and the fold line 43b is more readily foldable than the fold line 41b.

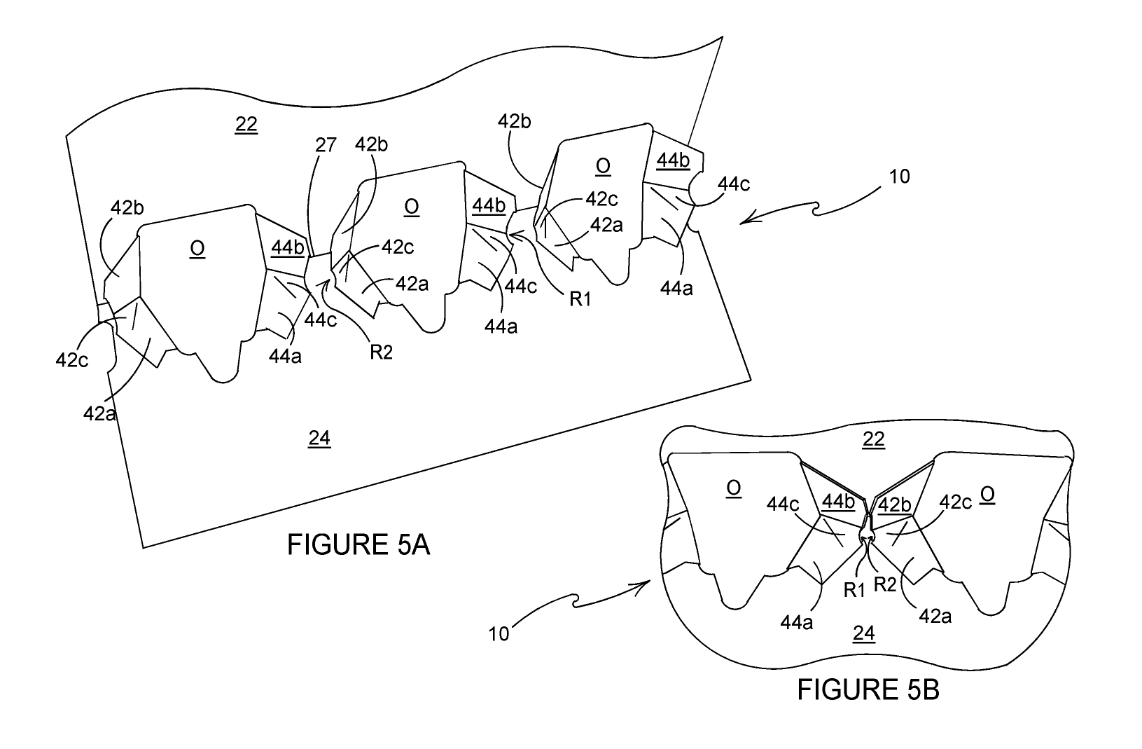

The aperture 46 defines a recess R1, R2 in each of the first and second tabs 42, 44, as shown in FIG. 5B. The recess R1 in a second tab 44 of a first lower article retention structure L and the recess R2 in a first tab 42 of a second, adjacent, lower article retention structure L cooperate so as to allow both tabs to be folded without overlapping or otherwise interfering with each other. In particular this is advantageous when folding the blank 10 so as to reduce the inherent resilience of the material forming the blank 10.

The blank 10 may be partially unfolded from the condition shown in FIG. 6C, as indicated by direction arrow F5. The second base panel 24 is partially unfolded about fold line 27, with respect to the second lower side panel 22.

The carton 90 is constructed about a group of articles by folding the first and second upper side wall panels 16, 20 about the group of articles by placing the top panel 18 over the group of articles A and folding about respective fold lines 19, 21.

The optional fold lines 17, 23, when provided, allow the lower side wall panels 14, 22 to be folded about the lower regions of the group of articles A. It is envisaged that in embodiments for accommodating articles having substantially parallel sides fold lines 17, 23 may be omitted.

The first and second base panels 12, 24 are then brought about the base of the group of articles. FIG. 6E illustrates the second base panel 24 being moved into position below the bases of a selection of the group of articles A. The first and second base panels 12, 24 are brought into at least partial overlapping arrangement such that male tabs M may be inserted through apertures in the second base panel 24 defined by female tabs F. Preferably the second base panel 24 is disposed innermost.

Each of the lower article retention structures L receives a portion of a respective article in an opening O (see FIGS. 5A and 5B) created by folding the first and second tabs 42, 44 internally of the carton 90. Each of the first tabs 42 substantially engages with a first side of an article A and each of the second tabs 44 substantially engages with a second side of an article A. As the lower article retention structures L receive a portion of a respective article A the first and second tabs 42, 44 are folded about the fold lines 43a, 43b as the first and second tabs 42, 44 are brought into contact with the article A; in this way the article acts as a mandrel for folding the first and second tabs 42, 44.

First and second top end flaps 36, 38 are folded downwardly about upper ends of the fold lines 29, 39 respectively. Preferably, this is done simultaneously with folding the first and second upper side wall panels 16, 20 about the group of articles A. The gusset panels are folded into flat face contacting relationship with the respective one of the first or second upper side wall panels 16, 20 from which they are struck.

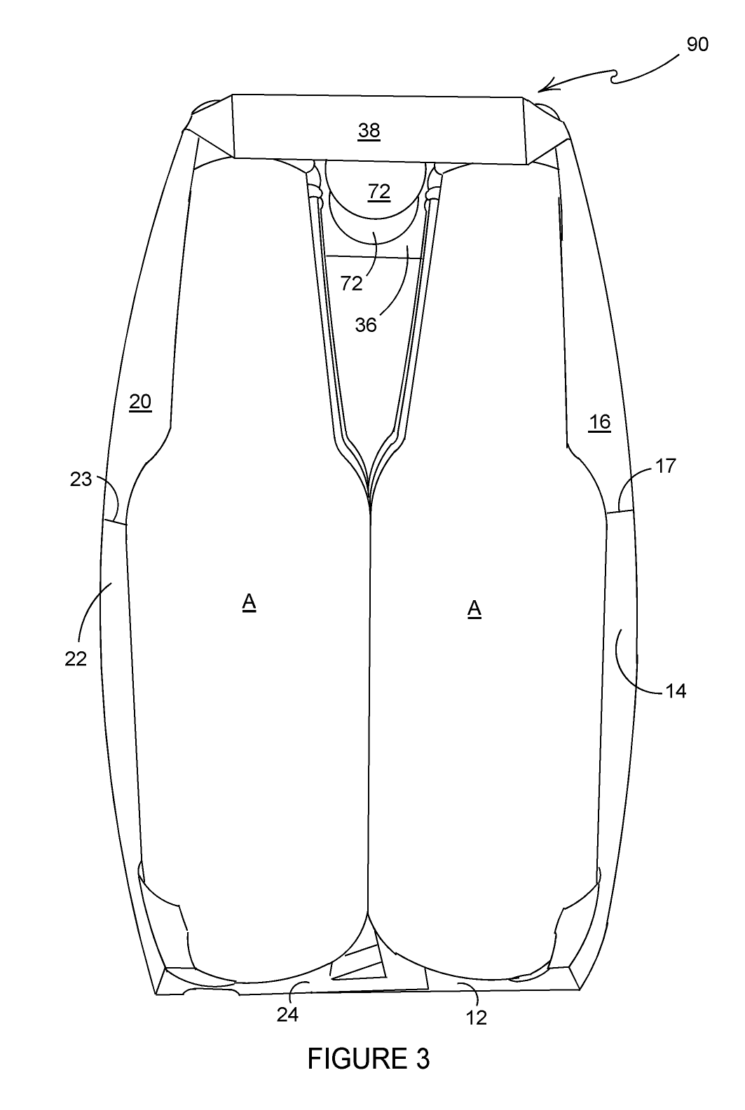

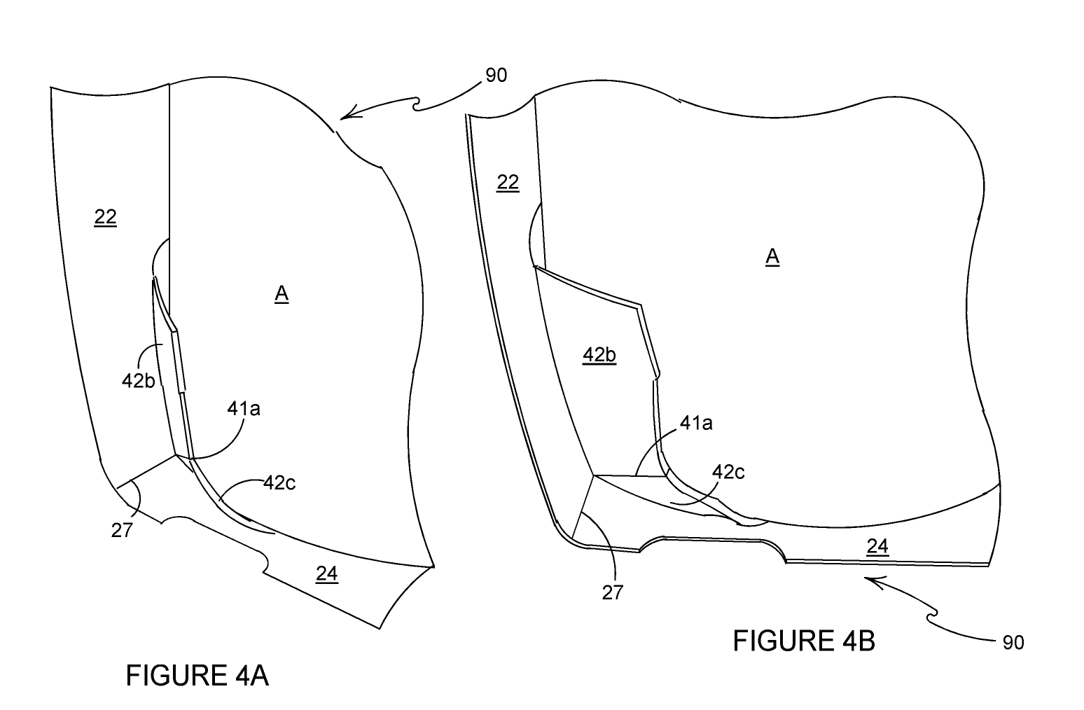

The assembled carton 90 is shown in FIGS. 2 and 3. FIGS. 4A and 4B illustrate the lower article retention structures L in use. The first and second upper portions 42b, 44b are disposed adjacent to the side walls of the articles A. The first and second lower portions 42a, 44a are disposed under the article A. The first and second lower portions 42a, 44a are disposed between the base of the article A and the second base panel 24.

The first and second central portion 42c, 44c are formed about the article A, the article A comprises a transition region between the side wall and the base the transition region may be curved or bevelled. The first and second central portion 42c, 44c each form a transition tab which is disposed adjacent to and in close proximity to the transition region of the article A. In this way a close fit is formed between the lower article retention structures L and the article A, this increases the security of the article A within the carton.

It can be appreciated that various changes may be made within the scope of the present invention, for example, the size and shape of the panels and apertures may be adjusted to accommodate articles of differing size or shape.

Whilst the foregoing embodiments have been described with reference to a wraparound style carton it is envisaged that the article retention structure may be employed in cartons of alternative design, such as but not limited to fully enclosed cartons, basket carries and top gripping clips.

It will be recognized that as used herein, directional references such as “top”, “base”, “front”, “back”, “end”, “side”, “inner”, “outer”, “upper” and “lower” do not limit the respective panels to such orientation, but merely serve to distinguish these panels from one another. Any reference to “hinged connection” should not be construed as necessarily referring to a single fold line only; indeed it is envisaged that a hinged connection can be formed from one or more of the following: a short slit, a frangible line or a fold line, without departing from the scope of the invention. It can be appreciated that various changes may be made within the scope of the present invention. For example, the size and shape of the panels and apertures may be adjusted to accommodate articles of differing size or shape.

As used herein, the terms “hinged connection” and “fold line” each refers to all manner of lines that define hinge features of the blank or substrate of sheet material, facilitate folding portions of the blank or substrate of sheet material with respect to one another, or otherwise indicate optimal panel folding locations for the blank or substrate of sheet material. Any reference to “hinged connection” should not be construed as necessarily referring to a single fold line only; indeed a hinged connection can be formed from one or more fold lines.

As used herein, the term “fold line” may refer to one of the following: a scored line, an embossed line, a debossed line, a line of perforations, a line of short slits, a line of half-cuts, a single half-cut, an interrupted cut line, aligned slits, a line of short scores and any combination of the aforesaid options, without departing from the scope of the invention.

As used herein, the term “severance line” may refer to all manner of lines formed in the blank or substrate of sheet material that facilitate separating portions of the blank or substrate of sheet material from one another, or otherwise that indicate optimal separation locations on the blank or substrate. As used herein, the term “severance line” may refer to one of the following: a single cut line, a single partial-depth cut line (e.g., a single half-cut line), an interrupted cut line, a score line, an interrupted score line, a line of perforations, a line of short cuts, a line of short slits, a line of short partial-depth cuts (e.g., a line of short half cuts), and any combination of the aforementioned options.

It should be understood that hinged connections, fold lines and severance lines can each includes elements that are formed in the blank or substrate of sheet material, including perforations, a line of perforations, a line of short slits, a line of half-cuts, a single half-cut, a cut line, an interrupted cut line, slits, scores, any combination thereof, and the like. The elements can be dimensioned and arranged to provide the desired functionality. For example, a line of perforations can be dimensioned or designed with degrees of weakness to define a fold line and/or a severance line. The line of perforations can be designed to facilitate folding and resist breaking to provide a fold line, to facilitate folding and facilitate breaking with more effort to provide a frangible fold line, or to facilitate breaking with little effort to provide a severance line.

As used herein, the term “wraparound carrier” typically refers to a carrier having four primary walls (top, first side, base and second side) that form a sleeve style structure generally having open ends. An article group is tightly wrapped by the carrier which is held in place about the article group by means of a tightly assembled composite top wall or a composite base wall.

1. A carton for packaging one or more articles, the carton comprising a first side panel and first base panel hingedly connected by a fold line, the carton comprising at least one article retention structure for engaging a lower portion of an article, the article retention structure comprising at least a first tab struck from, and hingedly connected to, the first side panel and/or the first base panel, wherein the at least a first tab comprises an upper portion, a lower portion and a central portion, the central portion hingedly interconnecting the upper and lower portions and being defined by a pair of fold lines, the fold lines of the pair being divergently arranged with respect to each other and wherein one of said fold lines of the pair is arranged such that the lower portion of the at least a first tab is foldable to form an acute angle with respect to the upper portion when the first base panel is folded to form an acute angle with respect to first side panel.

2. A carton according to claim 1 wherein said one of said fold lines of the pair is less foldable than the other of said fold lines of the pair.

3. A carton according to either of claims 1 wherein the at least one article retention structure comprises a first article retention structure and a second article retention structure each comprising the at least a first tab, the at least a first tab of each of the first and second article retention structures comprising a cutaway struck at least in part from the upper portion, the cutaways being arranged to prevent the at least a first tab of the first article retention structure from overlapping with the at least a first tab of second article retention structure when the at least a first tab of the first article retention structure and the at least a first tab of the second retention structure are disposed in an fully open condition in which they engage articles respectively.

4. A carton according to claim 1 wherein the at least one article retention structure comprises a first tab and a second tab each comprising an upper portion, a lower portion and a central portion, the central portion hingedly interconnecting the upper and lower portions and being defined by a pair of fold lines, the fold lines of the pair being divergently arranged with respect to each other and wherein an aperture is struck at least in part from the upper portions of the first and second tabs so as to form a cutaway in each of the first and second tabs.

5. A carton according to claim 1 wherein the lower portion of the at least a first tab is foldable into face contacting relationship with the first base panel so as to be disposable between the base panel and an article received in the at least one article retention structure.

6. A carton according to claim 1 wherein the lower portion of the at least a first tab is struck at least in part from the first base panel.

7. A carton according to claim 1 wherein the upper portion of the at least a first tab is struck at least in part from the first side panel.

8. A carton according to claim 1 wherein the central portion of the at least a first tab is struck at least in part from the first side panel.

9. A carton according to claim 1 wherein the central portion of the at least a first tab is struck at least in part from the first base panel.

10. A carton according to claim 1 wherein the pair of fold lines converge at the fold line hingedly connecting the first base panel to the first side panel.

11. A carton for packaging one or more articles, the carton comprising a first side panel and first base panel hingedly connected by a fold line, the carton comprising a first article retention structure and a second article retention structure each for engaging a lower portion of a respective article, each of the first and second article retention structures comprising at least a first tab struck from, and hingedly connected to, the first side panel and/or the first base panel, wherein each of the at least a first tab comprise an upper portion, a lower portion and a central portion, the central portion hingedly interconnecting the upper and lower portions and being defined by a pair of fold lines, and wherein each of the at least a first tab of the first article retention structure and the at least a first tab of the second article retention structure comprises a cutaway struck at least in part from their respective upper portions, the cutaways being arranged to prevent the at least a first tab of the first article retention structure from overlapping with the at least a first tab of the second article retention structure when the at least a first tab of the first retention structure and the at least a first tab of the second article retention structure are disposed in a fully open condition in which they engage their respective articles.

12. A carton according to claim 11 wherein the one of said fold lines of the pair is less foldable than the other of said fold lines of the pair.

13. A method of constructing a carton from a blank, the blank comprising:
a first side panel and a first base panel hingedly connected by a first fold line, the blank comprising at least one article retention structure for engaging a lower portion of an article, the at least one article retention structure comprising at least a first tab struck from, and hingedly connected to, the first side panel and/or the first base panel, wherein the at least a first tab comprises an upper portion, a lower portion and a central portion, the central portion hingedly interconnecting the upper and lower portions and being defined by a pair of second and third fold lines, the second and third fold lines being divergently arranged with respect to each other; wherein the method comprises the steps of:
folding the at least a first tab from a position wherein the upper portion is in the plane of the first side panel towards an inner surface of the first side panel such that the at least one article retention structure is in an open condition;
folding the first base panel with respect to the first side panel along the first fold line such that an acute angle is defined between the first base panel and the first side panel;
folding the at least a first tab about one of the second and third fold lines simultaneously with said folding step for the first base panel;
allowing the first base panel to be folded in a reverse direction such that an angle greater than said acute angle is defined between the first base panel and the first side panel and such that the at least one article retention structure remains in the open condition; and
transferring the blank to a subsequent processing station in a packaging machine whilst the at least one article retention structure is in the open condition.

14. A method according to claim 13, further comprising:
pre-folding the first base panel with respect to the first side panel along the first fold line prior to the folding of the at least one article retention structure into the open condition.

15. A method according to claim 13, wherein the blank comprises a top panel and after the transferring step, the method further comprises the steps of:
transferring the blank with respect to at least one article such that the top panel is disposed proximate a top of the at least one article;
folding the first side panel toward a first side of the at least one article;
folding the first base panel toward a base of the at least one article;
receiving a portion of the at least one articles in the at least one article retention structure and in response folding the at least a first tab about the other of the second and third fold lines.

16. A blank for forming a carton, the blank comprising a first side panel and first base panel hingedly connected by a fold line, the blank comprising at least one article retention structure for engaging a lower portion of an article, the article retention structure comprising at least a first tab struck from, and hingedly connected to, the first side panel and/or the first base panel, wherein the at least a first tab comprises an upper portion, a lower portion and a central portion, the central portion hingedly interconnecting the upper and lower portions and being defined by a pair of fold lines, the fold lines of the pair being divergently arranged with respect to each other and wherein one of said fold lines of the pair is arranged such that the lower portion of the at least a first tab is foldable to form an acute angle with respect to the upper portion when the first base panel is folded to form an acute angle with respect to first side panel.

17. A blank for forming a carton, the blank comprising a first side panel and first base panel hingedly connected by a fold line, the blank comprising a first article retention structure and a second article retention structure each for engaging a lower portion of a respective article, each of the first and second article retention structures comprising at least a first tab struck from, and hingedly connected to, the first side panel and/or the first base panel, wherein each of the at least a first tab of the first article retention structure and the at least a first tab of the second article retention structure comprises an upper portion, a lower portion and a central portion, the central portion hingedly interconnecting the upper and lower portions and being defined by a pair of fold lines, the fold lines of the pair being divergently arranged with respect to each other and wherein the at least a first tab of the first article retention structure and the at least a first tab of the second article retention structure comprise cutaways struck at least in part from their respective upper portions, the cutaways being arranged to prevent the at least a first tab of the first article retention structure from overlapping with the at least a first tab of the second article retention structure when the at least a first tab of the first article retention structure and the at least a first tab of the second article retention structure are disposed in a fully open condition and engage their respective articles.
